(19) United States
(12) Patent Application Publication
(10) Pub. No.: US 2003/0177339 A1
(43) Pub. Date: Sep. 18, 2003

(54) Optimization of a pipelined processor system

(76) Inventor: Nils Ola Linnermark, Farsta (SE)

Correspondence Address: NIXON & VANDERHYE, PC, 1100 N GLEBE ROAD, 8TH FLOOR, ARLINGTON, VA, 22201-4714, US

(21) Appl. No.: 10/380,694

(22) PCT Filed: Jun. 1, 2001
(86) PCT No.: PCT/SE01/01234

(30) Foreign Application Priority Data
Sep. 22, 2000 (SE) 0003398-5

(51) Int. Cl. G06F 9/30

(52) U.S. Cl. 712/218

(57) ABSTRACT

A problem in a message-based pipelined processor system is that the pipelining features of the execution pipeline of the system can not be fully utilized when the first stages of the pipeline are awaiting the determination of a memory address by the last stage of the pipeline. The invention therefore proposes that the message-based memory addresses are determined before the messages are buffered, or even earlier, already at message sending, so that the memory addresses are ready for use as soon as message processing by the pipeline is intiated. This typically means that the address determination routine of the operating system is executed, and that the corresponding memory address is included in the relevant message before the message is buffered in the message buffers. In this way, the memory address can be loaded into the program counter and the instructions fetched right away as soon as message processing is initiated. This results in a more optimal utilization of the execution pipeline and a saving of execution time that is equal to the length of the execution pipeline (10-30) clock cycles or more). In order to handle applications with high real-time requirements, the invention introduces an update marker for indicating updates in the table used for determining the memory addresses.

### TECHNICAL FIELD OF THE INVENTION

The present invention generally relates to a message-based pipelined processor system, and a method of operating such a system in order to improve the performance thereof.

### BACKGROUND OF THE INVENTION

Many processor systems of today are built around a pipelined processor to which requests in the form of messages are transferred for processing. Typically, incoming messages as well as internally generated messages are buffered, awaiting processing by the operating system and the pipelined processor. The messages often include pointers to software instructions or data in the system memory, and the corresponding memory addresses to these instructions or data are typically determined by one or more table look-ups.

The execution of an instruction usually involves a number of consecutive steps to be performed. In a pipelined processor, each step is implemented as an independent stage in an assembly-line type of process. Typically, a pipelined processor includes an instruction fetch stage, one or more instruction decode stages, an operand read stage, an execution stage as well as a stage for storing and forwarding the results of the execution.

Since the pipeline stages operate independently, a new instruction may enter the fetch stage as soon as the previous instruction has been transferred to the decode stage and so on. Maximum throughput is achieved when all stages of the pipeline are occupied. This means that under ideal circumstances, a pipelined processor can produce a result on each clock cycle. In practice, however, pipelined processors are not fully utilized at all times, and there is a basic need to improve the performance of pipelined processor systems.

### SUMMARY OF THE INVENTION

The present invention overcomes these and other drawbacks of the prior art arrangements.

It is a general object of the present invention to improve the performance of a message-based pipelined processor system.

In particular, it is desirable to utilize the pipelined processor more optimally.

These and other objects are met by the invention as defined by the accompanying patent claims.

The invention is based on the recognition that conventional pipelined processors operate inefficiently at the start of execution of new program instruction sequences and at the start of data accesses because the pipeline can not start fetching instructions or reading data until the memory address to the beginning of a new program instruction sequence or to the relevant data has been determined by the pipeline and the resulting address has been forwarded by the last stage of the pipeline. This means that the pipeline will be emptied, or at least not optimally utilized, at address determination, and that the different stages of the pipeline will have to be filled with instructions all over again.

The general idea according to the invention is therefore to determine the memory address before the corresponding message is buffered, preferably already at message sending so that the memory address is ready for use as soon as message processing is initiated. In this way, the instructions can be fetched right away, and the pipeline will be more optimally utilized. In practice, there will be a saving of time that corresponds to the length of the pipeline, i.e. typically 10-30 clock cycles or more. This saving of time is expected to increase in the future because of the general development in processor technology, and because the ratio between memory access times and clock cycle times is expected to increase.

This mechanism has turned out to be useful in its own right in applications with low real time requirements.

In applications with higher real time requirements, it may seem more or less impossible to utilize the above mechanism. As messages normally are held in message buffers for some time before they are used, the time period between address determination and message processing may be relatively long. In this period of time, the look-up table or tables for determining the memory addresses may have been updated, e.g. due to re-arrangements in the software code in the system memory. This means that the memory addresses determined at message buffering or at message sending may not be relevant any longer when the message processing is initiated. Therefore, all buffered messages have to be processed and the buffers emptied before any rearrangement of the software code can take place. Not until the re-arrangement of the software code has taken place and the look-up tables have been updated, is it possible to start buffering new messages. This leads to substantial delays that can not be accepted in applications with relatively high real-time requirements.

The invention solves this severe and critical problem in an efficient and elegant manner by introducing an update marker that indicates whether any updates of the look-up table or tables have been made in the period between the address determination and the processing of the corresponding message. If the update marker indicates the occurrence of a look-up table update, the address determination is repeated at message processing by consulting the updated look-up table or tables again. If no updates have been made, the already determined memory address can be used right away, leading to a considerable saving of execution time. This only causes a re-determination of the memory address in connection with actual look-up table updates.

The invention is not only applicable to the start of execution of new program instruction sequences, but also to other situations, such as data accesses, where it is advantageous to have the memory addresses ready at message processing.

Other advantages offered by the present invention will be appreciated upon reading of the below description of the embodiments of the invention.

### BRIEF DESCRIPTION OF TIE DRAWINGS

The invention, together with further objects and advantages thereof, will be best understood by reference to the following description taken together with the accompanying drawings, in which:

FIG. 1 is a schematic overview of a pipelined processor system according to a preferred embodiment of the invention;

FIG. 2 is a schematic diagram illustrating a logical view of an exemplary execution pipeline used by the invention;

FIG. 3 is a schematic diagram illustrating an exemplary table look-up procedure used by the invention; and

FIG. 4 is a schematic flow diagram of a method of operating a pipelined processor system according to a preferred embodiment of the invention.

### DETAILED DESCRIPTION OF EMBODIMENTS OF THE INVENTION

Throughout the drawings, the same reference characters will be used for corresponding or similar elements.

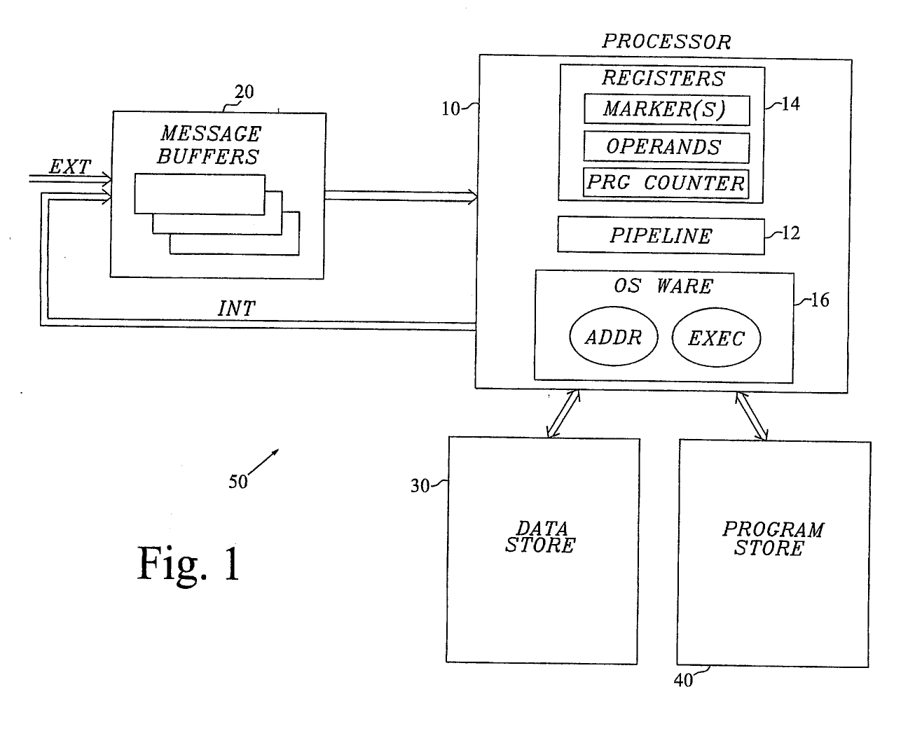

For a better understanding of the invention it is useful to begin with a general overview of an illustrative pipelined processor system, referring to FIG. 1.

FIG. 1 is a schematic overview of a pipelined processor system according to a preferred embodiment of the invention. The system 50 basically comprises a processor 10, associated message buffers 20, a data store 30 and a program store 40. External messages EXT as well as internal messages INT are buffered for some period of time in the message buffers 20, awaiting processing by the processor 10. The processor 10 is basically built around a conventional execution pipeline 12 having associated processor registers 14 and operating system (OS) ware 16. The operating system 16 typically comprises a number of routines for message handling such as address determination ADDR and program execution start EXEC routines. The operating system 16 may also include routines for fault handling, tracing as well as interrupt routines. Once a message is transferred from the message buffers 20 to the processor 10, one or more of the message handling routines of the operating system are executed in the pipeline 12 for initiating the task defined by the message. Typically such a task involves a data access and/or the execution of a certain program instruction sequence.

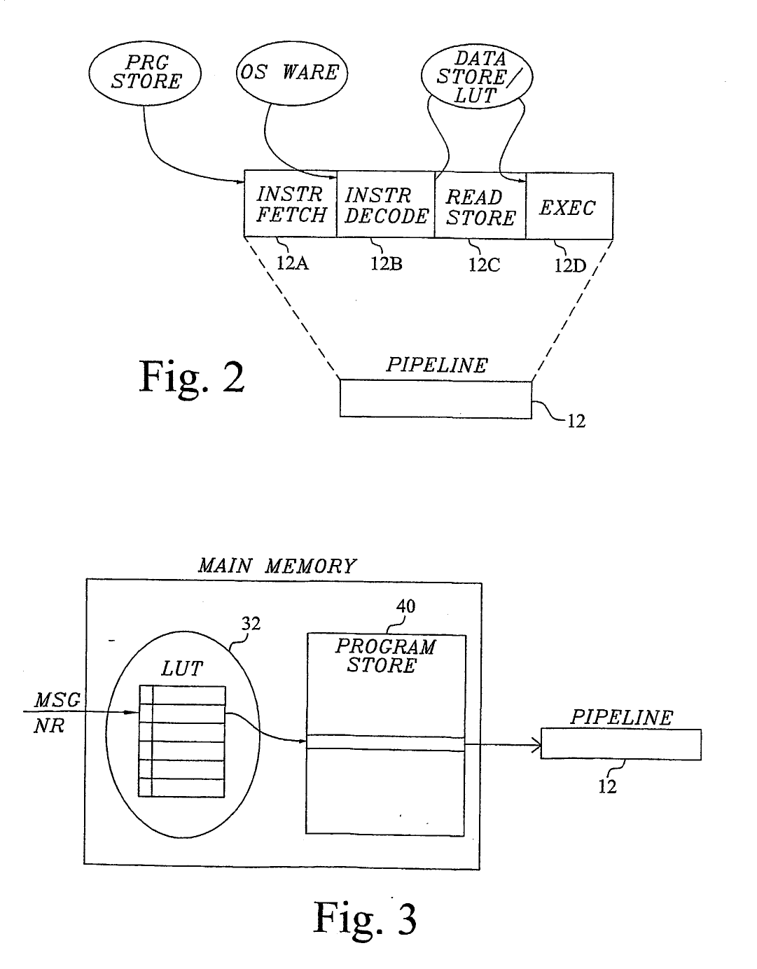

FIG. 2 is a schematic diagram illustrating a logical view of an exemplary execution pipeline used by the invention. The execution pipeline 12 basically comprises an instruction fetch stage 12A, one or more instruction decode stages 12B, a read store stage 12C and an execution stage 12D. Naturally, different pipelines have different number of stages as well as different stages, but the stages shown in FIG. 2 are some of the basic stages required in an execution pipeline.

For execution of a program instruction sequence, the program start address is copied into the program counter register (FIG. 1), and the corresponding instructions are fetched from the program store by the instruction fetch stage 12A and decoded in the instruction decode stage 12B. In the read store stage 12C, the required operands and/or data from the data store are loaded into a processor register and the decoded instructions are prepared for execution. Finally, the instructions are passed on to a set of execution units for execution during the execution stage 12D. Not shown in FIG. 2, but obvious to the skilled person is the result forwarding stage, in which the results are written to memory or sent as new messages for buffering.

For operating system routines, the corresponding instructions are loaded more or less directly into the instruction decode stage 12B in which they are decoded.

FIG. 3 is a schematic diagram illustrating an exemplary table look-up procedure used by the invention. In determining a memory address to be used by the pipeline in executing a task, one or more look-up tables (LUT) are normally consulted. For simplicity, only a single look-up table 32 will be considered in the following. When a memory address is to be determined the address determination routine ADDR (FIG. 1) of the operating system is invoked and executed by the pipeline. The address determination routine reads a memory address from the look-up table 32 in response to a message number MSG NR included in the corresponding message. The memory address found in the look-up table 32 typically points to the beginning of a program instruction sequence in the program store 40, or alternatively to a particular position in the data store of the system memory. Not until the program start address has been determined is it possible for the pipeline 12 to start fetching the instructions from the program store 40. This means that the pipeline normally will be empty when the program start address has been determined and forwarded by the last stage of the execution pipeline, since the new instructions can not be fetched by the first stage of the pipeline until the address has been fully determined. Thus, many of the pipeline stages will be idle for a rather long time since the address determination may take a large number of clock cycles, especially if a series of look-up tables have to be consulted.

In order to improve the performance of such a pipelined processor system, the invention therefore proposes that the message-based memory addresses are determined before the messages are buffered, or even earlier, already at message sending, so that the memory addresses are ready for use as soon as message processing is initiated. This typically means that the address determination routine of the operating system is executed, and that the corresponding memory address is included in the relevant message before the message is buffered in the message buffers. In this way, the memory address can be loaded into the program counter and the instructions fetched right away as soon as message processing is initiated. This results in a more optimal utilization of the execution pipeline and a saving of execution time that is equal to the length of the execution pipeline (10-30 clock cycles or more).

An example of an address determination routine ADDR that can be used by the invention will be given in pseudo-code below.

ADDR ROUTINE (at Message Sending or at Message Buffering):

START ADDR(MSG NR)

READ ADDRESS=LUT(MSG NR)

ADD ADDRESS TO MESSAGE

READ UPDATE MARKER VARIABLE

ADD MARKER VALUE TO MESSAGE

END ADDR

Based on system architecture and operation, it is decided whether it is better to determine the memory addresses already at message sending or in connection with message buffering. Under certain circumstances, it may be advantageous to coordinate the administrative task of determining the memory addresses for internal messages as well as external messages and determine all addresses in connection with message buffering. However, in other circumstances it is better to determine the addresses for internal messages in connection with message sending.

In applications with relatively high real time requirements, the above mechanism gives rise to potential disturbances and disruptions in the system operation when there is a change in the system that affects the look-up table. In a system based on message buffering, the time period between address determination and message processing may be rather long and system changes, such as re-arrangements in the software code, may result in updates in the look-up table or tables that are used for determining the memory addresses. This means that memory addresses determined at message buffering or at message sending may not be relevant any longer when message processing is initiated. Therefore, each time a re-arrangement of the software code is at hand, all the buffered messages have to be processed and the buffers emptied before the re-arrangement can take place. Not until the rearrangement of the software code has taken place and the look-up tables have been updated is it possible to start buffering new messages, and this naturally leads to substantial delays that can not be accepted in real-time applications.

The invention takes care of this severe problem by introducing an update marker that indicates whether any updates of the look-up table or tables have been made in the period between the address determination and the processing of the corresponding message. If a look-up table update is indicated, the memory address is re-determined at message processing by consulting the updated look-up table or tables. On the other hand, if no updates have been made, the already determined memory address can be used right away, thus leading to a considerable saving of execution time.

Preferably, the update marker is an operating system variable stored in a fast memory such as a processor register (FIG. 1) for fast access by the processor. For each update of the look-up table, the update marker in the processor register is stepped up by a value of 1. It should be understood that the update marking can either be table-entry specific or common for the entire look-up table.

Typically, the current value of the update marker is read at address determination and sent along with the corresponding message. At message processing, the update marker value in the processor register is compared to the update marker value included in the message in order to determine whether an update of the look-up table has been made in the period between address determination and message processing. If the comparison indicates that an older version of the look-up table has been used, the table look-up is repeated with the new updated look-up table.

An example of a program execution start routine EXEC according to the invention will be given in pseudo-code below.

EXEC ROUTINE (Message Processing):

START EXEC(MSG NR, ADDRESS, MARKER VALUE)

READ CURRENT VALUE OF UPDATE MARKER VALUE

IF CURRENT MARKER VALUE EQUALS MARKER VALUE IN

MESSAGE THEN

START PROGRAM EXECUTION AT ADDRESS

ELSE

READ ADDRESS=LUT(MSG NR)

START PROGRAM EXECUTION AT ADDRESS

END EXEC

For example, the update marker variable in the operating system is stepped up by means of a binary modulo-2ⁿ counter. Such a counter counts from zero to 2ⁿ−1, and then starts over again from zero. In order to prevent a wrap-around of the update marker in the period between address determination and message processing, the counter range has to be selected carefully so that the number of updates does not exceed the counter range in the time period during which the message is buffered. In applications where look-up table updates typically are caused by “manual” interference for re-arranging software code or changing trace indications, a counter range of 256 (corresponding to 8 bits) may be sufficient. In applications with more frequent look-up table updates, the counter range naturally has to be increased.

As mentioned above, the invention is not limited to a single look-up table. It is feasible to use a series of look-up tables or equivalent data structures in determining the memory addresses. For more information on the use of several look-up tables for so-called dynamic linking, reference is made to U.S. Pat. No. 5,297,285.

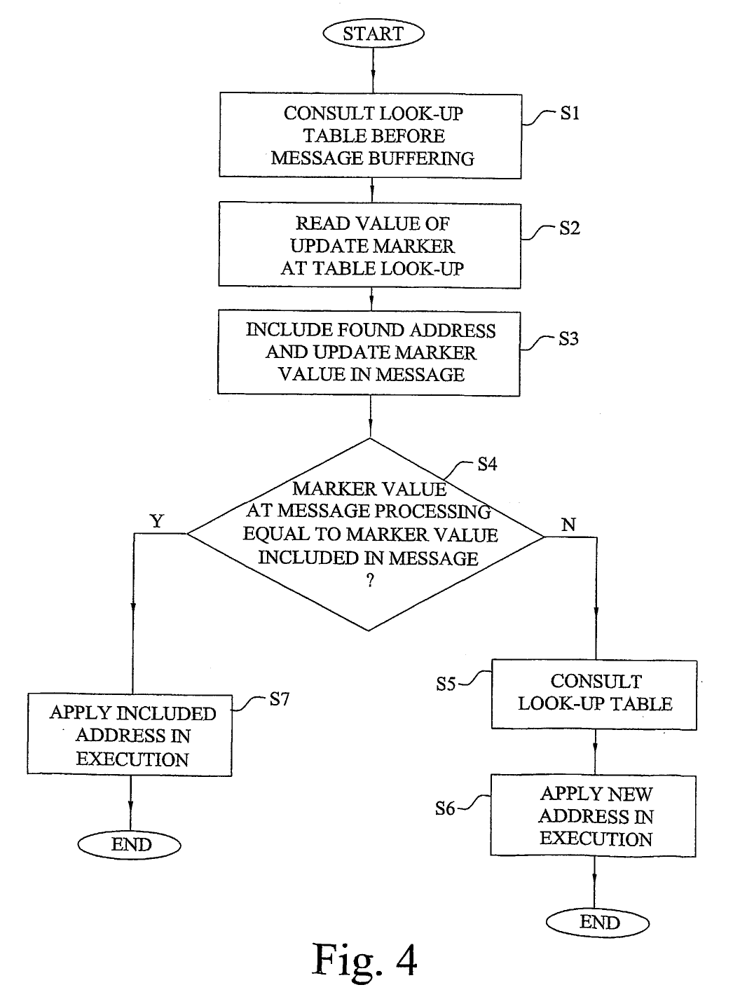

FIG. 4 is a schematic flow diagram of a method of operating a pipelined processor system according to a preferred embodiment of the invention. In step S1, a memory address for subsequent use by the pipelined processor is determined by consulting the look-up table before message buffering. In step S2, the current value of the update marker value in the processor register is read in connection with the table look-up. The found memory address and the update marker value are included into the corresponding message in step S3. At message processing, in step S4, the marker value in the processor register is compared to the marker value included in the message. In this way, it can be determined if there have been any updates of the look-up table used for determining the memory address. If the comparison indicates that the look-up table has been updated (Y), the operation continues in step S5 by consulting the look-up table again so that the memory address can be re-determined. In step S6, the new memory address is applied in the execution. On the other hand, if the comparison gives at hand that there haven't been any updates (N), the memory address sent along with the message can be applied directly in the execution, in step S7.

Although the invention mainly has been described with reference to determining a start address for program execution, it should be understood that reading of data from the data store or even an external database based on the determined memory address could be performed just as well. It is beneficial to have the memory address to the data store ready at message processing so that the read-out can be performed without unnecessary delays.

The invention is applicable to a wide variety of operating systems and programming environments, especially those based on asynchronous message handling. For example, the invention can be used with programming languages such as PLEX, Java, C++, OSE, Cello, TelOrb and Erlang. The invention is particularly applicable in the PLEX programming environment, where messages normally are in the form of internally generated job signals or job signals received from the external processors.

If the programming language or operating system is based on synchronous message handling, the situation becomes somewhat different. In this case, the look-up table (the same as for address determination or a separate one) includes information that indicates whether a message should be processed or buffered for synchronization purposes. The exact situation depends on the implementation of the operating system and execution environment. Typically, however, the access to synchronization information stored in the data store becomes the critical memory access instead of, or in addition to, the access of the program start memory address. Changes in the synchronization conditions in the look-up table will lead to updates in the look-up table, and usually the synchronization information is changed frequently. Therefore it is necessary to select the counter range carefully in order to prevent counter wrap situations.

A look-up table can also be used for holding trace indications to determine whether tracing in connection with the processed message should be initiated or not. Tracing is generally a question of keeping a log of the messages that have been sent/received. Usually, tracing is performed at message processing, but in accordance with a further embodiment of the invention tracing is performed before message buffering. This means that changes in the trace indications in the look-up table should also be regarded as an update of the look-up table, and followed by a re-examination of the trace indications in the look-up table. This means that the tracing of a message may be repeated at message processing if the look-up table has been updated. This also holds true for fault handling and fault detection and other similar procedures.

Although the invention has been described with reference to a processor with a single execution pipeline, it should be understood that the invention is applicable multi-pipeline processor systems as well.

The embodiments described above are merely given as examples, and it should be understood that the present invention is not limited thereto. Further modifications, changes and improvements which retain the basic underlying principles disclosed and claimed herein are within the scope and spirit of the invention.

1. A method of operating a message-based pipelined processor system, comprising the steps of:
buffering messages in at least one message buffer;
determining, before buffering a message, a corresponding memory address for subsequent use by the pipelined processor system at message processing, wherein the address determination is based on consulting at least one look-up table;
associating said look-up table with an update marker that is indicative of whether any updates of said look-up table have been made in the period between address determination and message processing, and thus indicative of whether the determined memory address is relevant when message processing is initiated.

2. The method according to claim 1, further comprising the step of re-determining said memory address at message processing if said update marker indicates the occurrence of an update of said look-up table.

3. The method according to claim 1, wherein said memory address is determined already at message sending.

4. The method according to claim 1, wherein said memory address is determined in connection with message buffering.

5. The method according to claim 1, wherein said address determining step includes the step of reading said memory address from said look-up table in response to information in said message, and said method further comprises the step of incorporating said memory address into said message before message buffering.

6. The method according to claim 1, wherein said step of consulting at least one look-up table includes the step of reading said memory address from said lookup table in response to information in said message, and said method further comprises the steps of:
incorporating said memory address into said message before message buffering;
associating said message with the value of said update marker at address determination;
comparing the value of said update marker at message processing with the marker value associated with said message at address determination; and
re-determining said memory address if the marker value at message determination differs from the marker value at message processing.

7. The method according to claim 1, wherein said method further comprises the steps of:
performing tracing and/or fault supervision in connection with said look-up table before message buffering; and
redoing said tracing and/or fault supervision at message processing if said update marker indicates the occurrence of an update of said look-up table.

8. The method according to claim 1, wherein said memory address is a jump address to the beginning of a program instruction sequence or a memory address for data access.

9. The method according to claim 1, wherein said pipelined processor system operates based on asynchronous message handling.

10. A message-based pipelined processor system comprising:
at least one message buffer for buffering messages;
means for determining, before buffering a message, a corresponding memory address for subsequent use by the pipelined processor system at message processing, wherein said address determining means includes means for consulting at least one look-up table to determine the memory address;
means for associating said look-up table with an update marker that is indicative of whether an update of said look-up table has been made in the period between address determination and message processing, and thus indicative of whether the determined memory address is relevant when message processing is initiated.

11. The system according to claim 10, further comprising means for re-determining said memory address at message processing if said update marker indicates the occurrence of an update of said look-up table.

12. The system according to claim 10, wherein said determining means is configured for determining said memory address already at message sending.

13. The system according to claim 10, wherein said determining means is configured for determining said memory address in connection with message buffering.

14. The system according to claim 10, wherein said address determining means includes means for reading said memory address from a look-up table in response to information in said message, and said system further comprises means for incorporating said memory address into said message before message buffering.

15. The system according to claim 10, wherein said consulting means includes means for reading said memory address from said look-up table in response to information in said message, and said system further comprises:
means for incorporating said memory address into said message before message buffering;
means for associating said message with the value of said update marker at address determination;
means for comparing the value of said update marker at message processing with the marker value associated with said message at address determination; and
means for re-determining said memory address if the marker value at address determination differs from the marker value at message processing.

16. The system according to claim 10, further comprising:
means for performing tracing and/or fault supervision in connection with said look-up table before message buffering; and
means for redoing said tracing and/or fault supervision at message processing if said update marker indicates the occurrence of an update of said look-up table.

17. The system according to claim 10, wherein said memory address is a jump address to the beginning of a program instruction sequence or a memory address for data access.

18. The system according to claim 10, wherein said pipelined processor system is based on asynchronous message handling.
